(19) United States
(12) Patent Application Publication
(10) Pub. No.: US 2021/0132231 A1
(43) Pub. Date: May 6, 2021

(54) VEHICLE SENSOR UNIT

(71) Applicant: TOYODA GOSEI CO., LTD., Kiyosu-shi (JP)

(72) Inventors: Mitsue TANAKA, Kiyosu-shi (JP); Tadaoki ICHIKAWA, Kiyosu-shi (JP); Akihiro MISAWA, Kiyosu-shi (JP)

(21) Appl. No.: 17/088,869

(22) Filed: Nov. 4, 2020

(30) Foreign Application Priority Data
Nov. 6, 2019 (JP) 2019-201469

(51) Int. Cl. G01S 17/931; G01S 17/06; G01S 17/58; G01S 13/06; G01S 13/58; G01S 13/931; B60S 1/46

(52) U.S. Cl. CPC G01S 17/931; G01S 17/06; G01S 17/58; B60S 1/46; G01S 13/58; G01S 13/931; G01S 13/06

(57) ABSTRACT

A vehicle sensor unit includes an infrared sensor configured to transmit an infrared ray to an outside of the vehicle, and receive an infrared ray reflected by a detection target object outside the vehicle, and a cover which is located in front of the infrared sensor in a transmission direction of the infrared ray to cover the infrared sensor and through which the infrared ray passes. A plurality of fine projection portions are formed on a surface of the cover on an opposite side of a surface on an infrared sensor side, at least in a region through which the infrared ray passes, and an interval between the projection portions that are adjacent to each other is equal to or smaller than a wavelength of the infrared ray.

### CROSS-REFERENCE TO RELATED APPLICATIONS

The present application claims the benefit of priority of Japanese Patent Application No. 2019-201469, filed on Nov. 6, 2019, the content of which is incorporated herein by reference.

### TECHNICAL FIELD

The present invention relates to a vehicle sensor unit provided at an outer end portion of a vehicle and having a function of detecting a situation around the vehicle.

### BACKGROUND ART

In the related art, as a vehicle sensor unit of this type, there is known an in-vehicle radar device as disclosed in JP-B-3659951, for example. Such an in-vehicle radar device includes a radio wave radar disposed at an outer end portion on a front end portion or the like of a vehicle, and a plate-shaped radome that is made of a radio wave-transmitting member and is disposed in front of the radio wave radar. The radio wave radar detects a detection target object by transmitting a radio wave to an outside of the vehicle and receiving a radio wave reflected by a detection target object outside the vehicle such as a preceding vehicle. The radome has a function of protecting the radio wave radar from rain or the like, and a function of covering the radio wave radar so as not to spoil an appearance of the vehicle.

However, when rainwater adheres to an outer surface (front surface) of the radome and a water film is formed, the radio wave is greatly attenuated when the radio wave is transmitted and received by the radio wave radar, so that the detection accuracy of the detection target object based on the radio wave radar is decreased. Therefore, in the in-vehicle radar device as described above, in order to prevent rainwater or the like from adhering to the outer surface of the radome and forming a water film, a plurality of recesses are formed in a grid pattern on the outer surface of the radome.

### SUMMARY OF INVENTION

In a case where an infrared sensor is used instead of the radio wave radar in the in-vehicle radar device described above, when the infrared sensor transmits and receives an infrared ray, the infrared ray is scattered by the plurality of recesses formed on the outer surface of the radome, so that a normal detection operation of the infrared sensor may be deteriorated.

The present invention has been made focusing on such a problem existing in the related art. An object of the present invention is to provide a vehicle sensor unit capable of preventing foreign matters from adhering to a surface of a cover that covers an infrared sensor while maintaining a normal detection operation of the infrared sensor.

Hereinafter, means for solving the above-described problem and effects thereof will be described.

According to the configuration, since the plurality of fine projection portions can enhance the liquid repellency of at least the region through which the infrared ray passes on the surface of the cover, the foreign matters such as rainwater, snow, and dirt are less likely to adhere to the region at least. In addition, since the interval between the adjacent projection portions is equal to or smaller than the wavelength of the infrared ray, the projection portions can be effectively prevented from affecting the transmission and reception of the infrared ray of the infrared sensor. Therefore, a normal detection operation of the infrared sensor can be maintained, and the foreign matters can be prevented from adhering to the surface of the cover that covers the infrared sensor.

According to the configuration, the projection portions can be effectively prevented from affecting the transmission and reception of the infrared ray of the infrared sensor even when the infrared ray includes both a P wave (longitudinal wave) and an S wave (transverse wave).

According to the configuration, in a case where dirt is fixed to at least the region through which the infrared ray passes on the surface of the cover, the washing liquid is sprayed onto the dirt by the washing machine, and thus the dirt can be quickly washed off.

According to the configuration, the washing liquid can be prevented from entering the gap between the adjacent projection portions on the surface of the cover. Therefore, a liquid film of the washing liquid can be prevented from being formed in the gap between the projection portions. When a liquid film of the washing liquid is formed in the gap between the projection portions, the detection operation of the infrared sensor is hindered.

According to the present invention, a normal detection operation of the infrared sensor can be maintained, and the foreign matters can be prevented from adhering to the surface of the cover that covers the infrared sensor.

### BRIEF DESCRIPTION OF DRAWINGS

FIG. 1 is a front view of a vehicle in which a vehicle sensor unit according to an embodiment is installed on a radiator grill.

FIG. 2 is an enlarged schematic cross-sectional view of a main part of FIG. 1.

FIG. 3 is a schematic diagram showing a state when a surface of a cover in FIG. 2 is washed.

FIG. 4 is an enlarged schematic cross-sectional view showing a part of the surface of the cover.

FIG. 5 is an enlarged schematic cross-sectional view showing a part of a surface of a cover according to a modification.

### DESCRIPTION OF EMBODIMENTS

Hereinafter, a vehicle sensor unit according to an embodiment will be described with reference to the drawings.

In the following description, a forward direction of a vehicle is described as a front direction and a reverse direction is described as a rear direction. Further, an upper-lower direction means an upper-lower direction of the vehicle, and a left-right direction is a width direction of the vehicle (vehicle width direction) and is the same as a left-right direction of the vehicle when the vehicle is moving forward.

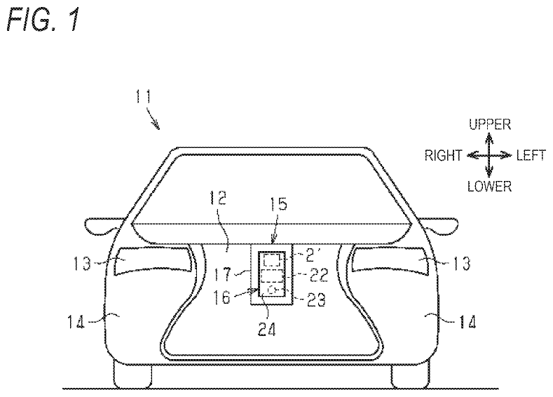

As shown in FIG. 1, a radiator grill 12, a pair of headlamps 13, and a pair of bumper-integrated fenders 14 are attached, as vehicle exterior components, to a front end portion of a vehicle body of a vehicle 11. The two headlamps 13 are respectively arranged on left and right sides of the radiator grill 12 and the two bumper-integrated fenders 14 are respectively arranged on the left and right sides of the radiator grill 12. The radiator grill 12 has a function of guiding external air such as traveling wind to a radiator (not shown) to cool the radiator.

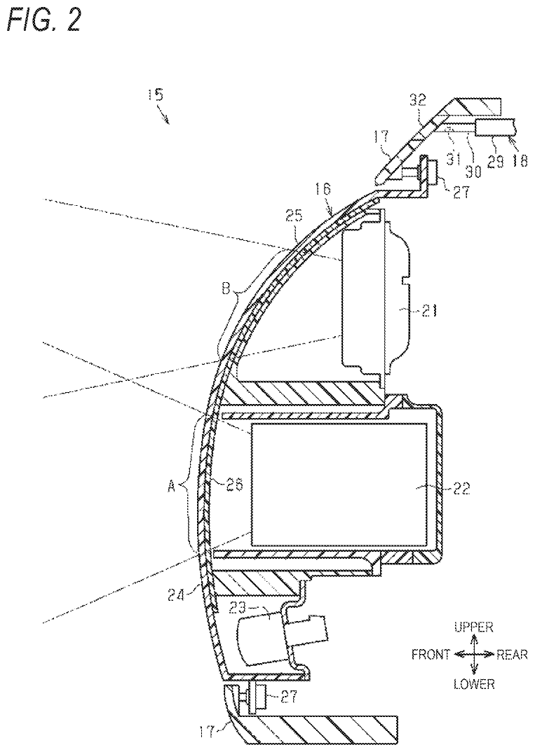

As shown in FIGS. 1 and 2, a vehicle sensor unit 15 having a function of detecting a situation around the vehicle 11 is provided on an upper portion of the radiator grill 12. The vehicle sensor unit 15 includes a unit body 16, a frame-shaped support member 17 for attaching the unit body 16 to the radiator grill 12, and a washing machine 18 provided on the support member 17. The radiator (not shown) is arranged behind the vehicle sensor unit 15 in the vehicle 11.

The unit body 16 is attached to the radiator grille 12 via the support member 17 in a state of being surrounded by the support member 17, and includes a millimeter wave radar device 21, an infrared sensor 22, a camera 23, which are arranged in a line in the upper-lower direction, and a cover 24 which covers these parts from front. Further, by attaching the millimeter wave radar device 21, the infrared sensor 22, and the camera 23 to the cover 24, the unit body 16 is configured as one unit.

The millimeter wave radar device 21 has a sensor function of transmitting a millimeter wave to an outside of the vehicle 11 in a predetermined angle range in front of the vehicle 11 and receiving a millimeter wave reflected by a detection target object outside the vehicle. A millimeter wave is a radio wave with a wavelength of 1 mm to 10 mm and a frequency of 30 GHz to 300 GHz.

The millimeter wave radar device 21 detects an inter-vehicle distance or a relative speed with respect to a preceding vehicle traveling in front of the vehicle 11 based on a time difference between a transmitted millimeter wave (transmitted wave) and a received millimeter wave (received wave), or intensity of the received wave, etc. The millimeter wave radar device 21 is resistant to bad weather such as rain, fog, and snow, and has a long measurable distance as compared to other methods.

The infrared sensor 22 is a component that constitutes a part of an infrared Lidar device, and is arranged at a position below and adjacent to the millimeter wave radar device 21. The infrared sensor 22 transmits an infrared ray to an outside of the vehicle in an angle range wider than that of the millimeter wave radar device 21, and receives an infrared ray reflected by an detection target object outside the vehicle including a preceding vehicle, a pedestrian or the like. The infrared ray is a type of electromagnetic wave and has a wavelength longer than that of visible light.

The infrared sensor 22 of the present embodiment preferably uses an infrared ray having a wavelength in a range of 800 nm to 2000 nm, and more preferably an infrared ray having a wavelength in a range of 800 nm to 1000 nm or 1300 nm to 1600 nm. The infrared sensor 22 sets, as a detection target, a detection target object in a position where a distance from the detection target object to the infrared sensor 22 is closer than a distance from a detection target object detected by the millimeter wave radar device 21 to the millimeter wave radar device 21. The infrared Lidar device measures the inter-vehicle distance or the relative speed between the preceding vehicle and the own vehicle (vehicle 11) based on the transmitted infrared ray (transmitted wave) and the received infrared ray (received wave).

The camera 23 is arranged at a position below and adjacent to the infrared sensor 22. The camera 23 is arranged at a position outside both a detection range of the millimeter wave radar device 21 and a detection range of the infrared sensor 22. The detection range of the millimeter wave radar device 21 is a range through which the millimeter wave transmitted from the millimeter wave radar device 21 passes and a range through which the millimeter wave reflected by the detection target object passes. The detection range of the infrared sensor 22 is a range through which the infrared ray transmitted from the infrared sensor 22 passes, and a range through which the infrared ray reflected by the detection target object passes.

The cover 24 is formed in a plate shape that is longer in the upper-lower direction than in the left-right direction, and is attached to the radiator grill 12 via the support member 17. The cover 24 is located in front of the infrared sensor 22 in a direction in which the infrared sensor 22 transmits the infrared ray, and covers the millimeter wave radar device 21, the infrared sensor 22, and the camera 23.

The cover 24 is made of a transparent resin material such as polycarbonate (PC), polymethylmethacrylate (PMMA), cycloolefin polymer (COP), and is transparent to millimeter waves, infrared rays, and visible light. Most of the cover 24 is curved so as to bulge forward. A surface 25 (front surface) of the cover 24, which is a surface on an opposite side of a surface on an infrared sensor 22 side, is exposed outside the vehicle.

A decorative layer 26 having a millimeter wave transmitting property and an infrared ray transmitting property is formed on substantially the entire back surface (rear surface) of the cover 24. The decorative layer 26 is formed of, for example, a colored coating film such as black. In this case, the decorative layer 26 is formed to cover the millimeter wave radar device 21 and the infrared sensor 22 and not to cover the camera 23.

Attachment portions 27 are formed at an upper end portion and a lower end portion of the cover 24, respectively. The cover 24 is attached to the support member 17 at these attachment portions 27 by clips, screws, claw engagement, or the like. The support member 17 is attached to the radiator grill 12 by clips, screws, claw engagement, or the like.

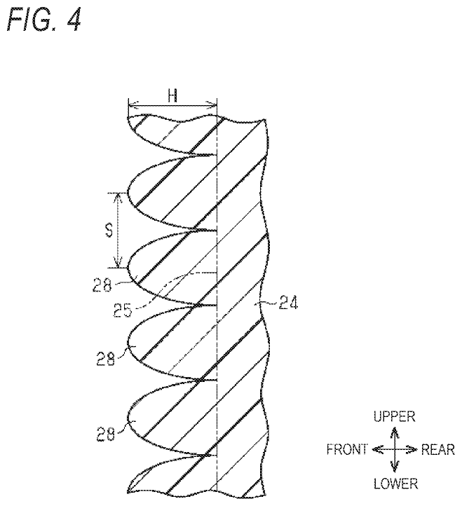

As shown in FIGS. 2 and 4, a plurality of fine projection portions 28 are uniformly formed over the entire surface 25 of the cover 24. Each projection portion 28 has a semi-elliptical shape in a cross-sectional view. In this case, an interval S between adjacent projection portions 28 is set to be equal to or smaller than the wavelength of the infrared ray transmitted from the infrared sensor 22. Further, in this case, a projection height H of each projection portion 28 from the surface 25 of the cover 24 is set to be equal to or smaller than the wavelength of the infrared ray transmitted from the infrared sensor 22.

The plurality of fine projection portion 28 can be formed on the surface 25 of the cover 24, for example, by spraying fine particles to the surface 25 of the cover 24, using a mold at the time of molding the cover 24, pasting a film in which the plurality of fine projection portions 28 are formed in advance, etc.

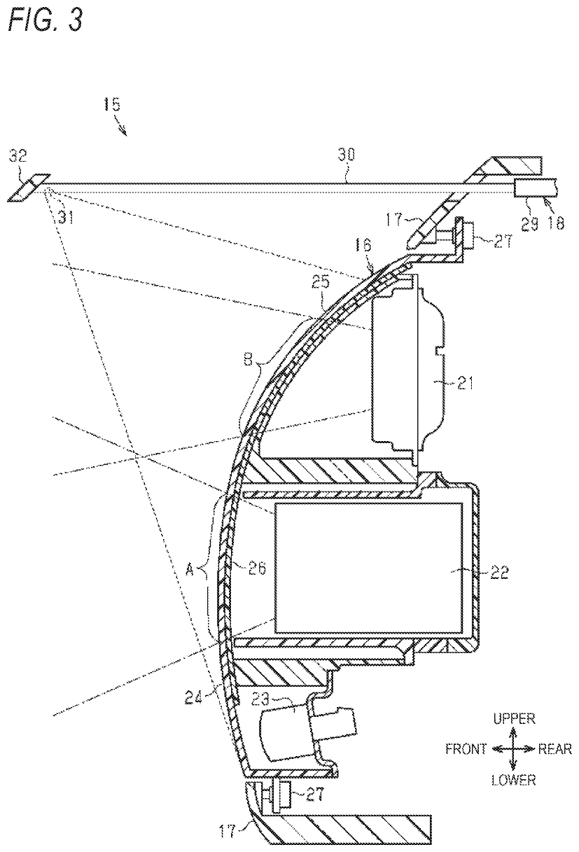

As shown in FIGS. 2 and 3, the washing machine 18 is provided behind an upper end portion of the support member 17. That is, the washing machine 18 is provided at a position above the unit body 16 so as to be covered by the support member 17 from front. The washing machine 18 includes an actuator 29 and a hollow rod 30 that is reciprocally moved in a front-rear direction by the actuator 29.

The rod 30 extends in the front-rear direction, and a washing liquid is supplied to an inside of the rod 30 from a washing liquid tank (not shown). A nozzle 31 for spraying the washing liquid supplied from the washing liquid tank (not shown) is formed below a front end portion of the rod 30. The front end of the rod 30 is coupled to the support member 17. A coupling portion between the rod 30 and the support member 17 and a portion in a vicinity thereof form a cut portion 32 cut from other portions of the support member 17.

Therefore, the cut portion 32 is reciprocally moved in the front-rear direction together with the rod 30 by the actuator 29. In this case, the actuator 29 moves the rod 30 between a spraying position (a position shown in FIG. 3) where the washing liquid can be sprayed from the nozzle 31 toward substantially the entire surface 25 of the cover 24 and a storage position (a position shown in FIG. 2) where the rod 30 is stored behind the support member 17.

Further, in this case, when the rod 30 is in the storage position, a front surface of the cut portion 32 and a surface of the support member 17 adjacent to the front surface of the cut portion 32 are flush with each other. An average droplet diameter of the washing liquid sprayed from the nozzle 31 of the rod 30 when the rod 30 is in the spraying position is set to be equal to or larger than the wavelength of the infrared ray transmitted from the infrared sensor 22.

An electronic control device (not shown) is mounted on the vehicle 11 as shown in FIGS. 1 and 2. The millimeter wave radar device 21, the infrared sensor 22, and the camera 23 described above are connected to the electronic control device. The electronic control device executes various processings for supporting the driving of the vehicle 11 according to the situations around the vehicle 11 which are grasped based on output signals of the millimeter wave radar device 21, the infrared sensor 22, and the camera 23.

Examples of the various processings include a processing of warning that the vehicle 11 may deviate from a lane, a processing of warning that the vehicle 11 may collide, a processing of automatically adjusting the inter-vehicle distance, and the like. The electronic control device controls drive of the washing machine 18.

Next, an operation of the vehicle sensor unit 15 configured as above will be described.

The millimeter wave radar device 21 of the vehicle sensor unit 15 transmits a millimeter wave to the outside of the vehicle. The millimeter wave passes through the cover 24 that is located in front of the millimeter wave radar device 21 in a millimeter wave transmission direction. The millimeter wave radar device 21 receives a millimeter wave that is reflected by another detection target object such as another vehicle or an obstacle in the millimeter wave transmission direction, and pass through the cover 24.

Further, an infrared ray is transmitted from the infrared sensor 22 of the vehicle sensor unit 15 toward the outside of the vehicle. The infrared ray passes through the cover 24 that is located in front of the infrared sensor 22 in a transmission direction of the infrared ray. The infrared sensor 22 receives an infrared ray that is reflected by another detection target object such as another vehicle or an obstacle in the transmission direction of the infrared ray, and passes through the cover 24. Further, the situation outside the vehicle 11 is imaged by the camera 23 through the cover 24.

Then, while the vehicle 11 is traveling, various foreign matters such as rainwater, snow, and dirt adhere to the surface 25 of the cover 24. In particular, when the foreign matters adhere to an infrared transmission region A and a millimeter wave transmission region B on the surface 25 of the cover 24, the transmission of millimeter wave by the millimeter wave radar device 21 and the transmission of the infrared ray by the infrared sensor 22 are blocked by the foreign matters. As a result, the detection accuracy of the detection target object by the millimeter wave radar device 21 and the detection accuracy of the detection target object by the infrared sensor 22 will be significantly reduced.

In this respect, in the vehicle sensor unit 15 according to the present embodiment, a plurality of fine projection portions 28 are formed on the entire surface 25 of the cover 24. Therefore, since a contact angle of the entire surface 25 of the cover 24 is increased and the liquid repellency is enhanced, the surface 25 of the cover 24 easily repels the foreign matters.

Therefore, since it is difficult for the foreign matters to adhere to the surface 25 of the cover 24, transmission of the millimeter wave by the millimeter wave radar device 21 and transmission of the infrared ray by the infrared sensor 22 are less likely to be blocked by the foreign matters. Therefore, the detection accuracy of the detection target object by the millimeter wave radar device 21 and the detection accuracy of the detection target object by the infrared sensor 22 are maintained.

Further, in particular, in a case where in the infrared transmission region A and the millimeter wave transmission region B on the surface 25 of the cover 24, for example, snow is frozen or mud is fixed, and the electronic control unit (not shown) determines that the detection accuracy of the detection target object by the millimeter wave radar device 21 and the detection accuracy of the detection target object by the infrared sensor 22 is decreased, the electronic control device drives the washing machine 18. Then, after the rod 30 is moved to the spraying position (position shown in FIG. 3) by the actuator 29, the washing liquid is sprayed from the nozzle 31 onto the entire surface 25 of the cover 24.

Accordingly, the frozen snow is melted on the surface 25 of the cover 24, and the dirt on the surface 25 of the cover 24 is wiped off. Then, due to the liquid repellency of the plurality of fine projection portions 28 formed on the entire surface 25 of the cover 24, snow and mud on the surface 25 of the cover 24 quickly flow off. In addition, since the average droplet diameter of the washing liquid sprayed from the nozzle 31 to the entire surface 25 of the cover 24 is equal to or larger than the wavelength of the infrared ray transmitted from the infrared sensor 22, that is, equal to or larger than the interval S between the adjacent projection portions 28 formed on the surface 25 of the cover 24, the washing liquid hardly enters the gap between the adjacent projection portions 28 to form a liquid film.

Further, in the plurality of fine projection portions 28 formed on the entire surface 25 of the cover 24, in order to make the entire surface 25 of the cover 24 liquid-repellent, the interval S between adjacent projection portions 28 and the projection height H from the surface 25 are both equal to or smaller than the wavelength of the infrared ray transmitted from the infrared sensor 22. Therefore, when the infrared sensor 22 transmits or receives an infrared ray, the infrared ray is hardly scattered or refracted by the projection portions 28.

Therefore, since the transmission of the millimeter wave by the millimeter wave radar device 21 and the transmission of the infrared ray by the infrared sensor 22 is hardly blocked by snow, mud, a liquid film of the washing liquid formed in the gap between the adjacent projection portions 28, and the projection portions 28, the detection accuracy of the detection target object by the millimeter wave radar device 21 and the detection accuracy of the detection target object by the infrared sensor 22 is maintained.

Thereafter, the rod 30 is moved to the storage position (position shown in FIG. 2) by the actuator 29 in a state where the spray of the washing liquid from the nozzle 31 is stopped, and the drive of the washing machine 18 is stopped. In this case, when the rod 30 is in the storage position, the front surface of the cut portion 32 and the surface of the support member 17 adjacent to the front surface of the cut portion 32 are flush with each other, the support member 17 hides the washing machine 18, so that the appearance is not deteriorated.

In this way, the surface 25 of the cover 24 is always kept in a clean state due to the liquid repellency of the plurality of fine projection portions 28 and the washing performed by the washing machine 18. Therefore, the millimeter wave radar device 21, the infrared sensor 22, and the camera 23 always function in a normal state.

According to the embodiment described in detail above, the following effects are exhibited.

(1) In the vehicle sensor unit 15, the plurality of fine projection portions 28 are formed on the surface 25 of the cover 24, and the interval S between adjacent projection portions 28 is equal to or smaller than the wavelength of the infrared ray transmitted from the infrared sensor 22. According to the configuration, since the plurality of fine projection portions 28 can enhance the liquid repellency of the surface 25 of the cover 24, the foreign matters such as rainwater, snow, and dirt are less likely to adhere to the surface 25. In addition, since the interval S between the adjacent projection portions 28 is equal to or smaller than the wavelength of the infrared ray, the projection portions 28 can be effectively prevented from affecting the transmission and reception of the infrared ray of the infrared sensor 22. Therefore, the normal detection operation of the infrared sensor 22 can be maintained, and the foreign matters can be prevented from adhering to the surface 25 of the cover 24 that covers the infrared sensor 22.

(2) In the vehicle sensor unit 15, the projection height H of the projection portion 28 from the surface 25 of the cover 24 is equal to or smaller than the wavelength of the infrared ray transmitted from the infrared sensor 22. According to the configuration, the projection portions 28 can be effectively prevented from affecting the transmission and reception of the infrared ray of the infrared sensor 22 even when the infrared ray transmitted from the infrared sensor 22 includes both a P wave (longitudinal wave) and an S wave (transverse wave).

(3) The vehicle sensor unit 15 includes a washing machine 18 that sprays a washing liquid to the surface 25 of the cover 24. According to the configuration, in a case where dirt is fixed to the surface 25 of the cover 24, the washing liquid is sprayed onto the dirt by the washing machine 18, and thus the dirt can be quickly washed off.

(4) In the vehicle sensor unit 15, the average droplet diameter of the washing liquid sprayed from the washing machine 18 is equal to or larger than the wavelength of the infrared ray transmitted from the infrared sensor 22. According to the configuration, the washing liquid can be prevented from entering the gap between the adjacent projection portions 28 on the surface 25 of the cover 24. Therefore, a liquid film of the washing liquid can be prevented from being formed in the gap between the projection portions 28. Therefore, it is possible to prevent the decrease in detection accuracy of the infrared sensor caused by the formation of a liquid film of the washing liquid in the gap between the projection portions 28. When a liquid film of the washing liquid is formed in the gap between the projection portions 28, the infrared ray transmitted from the infrared sensor 22 is scattered or refracted by the liquid film, which hinders the detection operation of the infrared sensor 22.

(5) In the vehicle sensor unit 15, the washing machine 18 is provided at a position above the unit body 16 so as to be covered by the support member 17 from front. That is, the washing machine 18 is configured to spray the washing liquid onto the surface 25 of the cover 24 from above the unit body 16. Therefore, when the washing liquid is sprayed from the washing machine 18 to the surface 25 of the cover 24, the washing liquid sprayed from the washing machine 18 and the dirt on the surface 25 of the cover 24 can be prevented from splashing on a hood of the vehicle 11 or polluting the washing machine 18. When the washing machine 18 is configured to spray the washing liquid onto the surface 25 of the cover 24 from below the unit body 16, the washing liquid sprayed from the washing machine 18 and the dirt on the surface 25 of the cover 24 fall off due to gravity and fall on the washing machine 18, so that the nozzle 31 may be clogged. In this case, in order to prevent the washing liquid sprayed from the nozzle 31 of the rod 30 of the washing machine 18 and the dirt on the surface 25 of the cover 24 from getting on the rod 30 and the nozzle 31 of the washing machine 18, after the rod 30 sprays the washing liquid from the nozzle 31 onto the surface 25 of the cover 24 in a state of being at the spraying position, it is necessary to move the rod 30 from the spray position to the storage position at an extremely high speed.

(Modification)

The above-described embodiment can be modified as follows. In addition, the above-described embodiment and the following modification can be implemented in combination with each other within a technically consistent range.

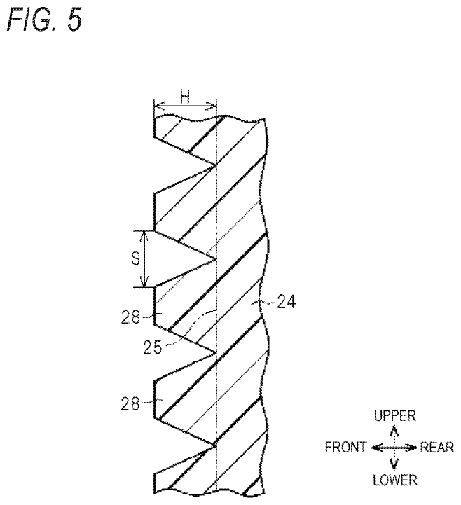

A shape of the projection portion 28 may be changed appropriately. That is, the shape of the projection portion 28 may be, for example, a trapezoidal shape in cross section as shown in FIG. 5, a semicircular shape in cross section, or a triangular shape in cross section.

The shapes of the plurality of projection portions 28 may be partially changed. That is, projection portions 28 having a plurality of types of shapes that are different from each other may be mixed in the plurality of projection portions 28.

The average droplet diameter of the washing liquid sprayed from the washing machine 18 need not necessarily be equal to or larger than the wavelength of the infrared ray transmitted from the infrared sensor 22.

The washing machine 18 may be omitted.

The washing machine 18 need not necessarily be configured to spray the washing liquid to the entire surface 25 of the cover 24 and may be configured to spray the washing liquid to at least the infrared transmission region A, which is a region through which the infrared ray transmitted from the infrared sensor 22 passes.

The washing machine 18 may be provided behind a lower end portion of the support member 17. That is, the washing machine 18 may be provided on the support member 17 at a position below the unit body 16 so as to be covered by the support member 17 from front. Alternatively, the washing machine 18 may be provided behind a left end portion or a right end portion of the support member 17.

The projection height H of each projection portion 28 from the surface 25 of the cover 24 need not necessarily be equal to or smaller than the wavelength of the infrared ray transmitted from the infrared sensor 22.

The plurality of fine projection portions 28 need not necessarily be formed on the entire surface 25 of the cover 24, and may be formed at least in the infrared transmission region A where the infrared ray transmitted from the infrared sensor 22 passes.

The plurality of fine projection portions 28 need not necessarily be formed uniformly on the surface 25 of the cover 24. For example, if the interval S between adjacent projection portions 28 is equal to or smaller than the wavelength of an infrared ray transmitted from the infrared sensor 22, the density of the projection portions 28 formed on the surface 25 of the cover 24 may be partially changed.

The projection heights H of the projection portions 28 formed on the surface 25 of the cover 24 may be partially changed. In this case, the projection height H of the projection portion 28 is preferably set to be equal to or smaller than the wavelength of the infrared ray transmitted from the infrared sensor 22.

At least one of the millimeter wave radar device 21 and the camera 23 may be omitted.

The vehicle sensor unit 15 can be applied to a vehicle that does not have the radiator grill 12, for example, a rear engine/rear drive vehicle. In this case, the vehicle sensor unit 15 may be provided, for example, below the headlamp, at a bumper, a fender, or the like.

The vehicle sensor unit 15 may be provided at an outer end portion different from the front end portion of the vehicle 11, for example, at a rear end portion of the vehicle 11, so as to detect a situation around the vehicle 11.

What is claimed is:

1. A vehicle sensor unit provided at an outer end portion of a vehicle and having a function of detecting a situation around the vehicle, the vehicle sensor unit comprising:
an infrared sensor configured to transmit an infrared ray to an outside of the vehicle, and receive an infrared ray reflected by a detection target object outside the vehicle; and
a cover which is located in front of the infrared sensor in a transmission direction of the infrared ray to cover the infrared sensor and through which the infrared ray passes, wherein
a plurality of fine projection portions are formed on a surface of the cover on an opposite side of a surface on an infrared sensor side, at least in a region through which the infrared ray passes, and
an interval between the projection portions that are adjacent to each other is equal to or smaller than a wavelength of the infrared ray.

2. The vehicle sensor unit according to claim 1, wherein
a projection height of the projection portion from the surface of the cover is equal to or smaller than the wavelength of the infrared ray.

3. The vehicle sensor unit according to claim 1 further comprising:
a washing machine configured to spray a washing liquid onto at least the region through which the infrared ray passes on the surface of the cover.

4. The vehicle sensor unit according to claim 2 further comprising:
a washing machine configured to spray a washing liquid onto at least the region through which the infrared ray passes on the surface of the cover.

5. The vehicle sensor unit according to claim 3, wherein
an average droplet diameter of the washing liquid sprayed from the washing machine is equal to or larger than the wavelength of the infrared ray.

6. The vehicle sensor unit according to claim 4, wherein
an average droplet diameter of the washing liquid sprayed from the washing machine is equal to or larger than the wavelength of the infrared ray.
